(19) United States
(12) Patent Application Publication
(10) Pub. No.: US 2008/0166913 A1
(43) Pub. Date: Jul. 10, 2008

(54) View portal seating indicator

(75) Inventors: Larry Norman Siebens, Ashbury, NJ (US); Anthony Reed, Murray, NJ (US); Roger Provencal, Washington, NJ (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 12/008,049

(22) Filed: Jan. 8, 2008

Related U.S. Application Data
(60) Provisional application No. 60/879,297, filed on Jan. 8, 2007.

(51) Int. Cl. H01R 13/641

(52) U.S. Cl. 439/489; 439/181

(57) ABSTRACT

A view portal seating indicators for loadbreak and deadbreak connectors that includes: an elbow connector with an elbow cuff having an extended portion at the end and a plurality of openings located circumferentially on the extended portion; and a bushing insert having a mid-section and an indicating band extending around a portion of the midsection. Proper insertion of a bushing insert into the elbow connector permits the indicating band to be viewed through the openings and indicates that the connection is properly made. In another embodiment the openings are notches located at the end of the extended portion. Proper insertion of a bushing insert into the elbow connector permits the indicating band to be viewed through the notches and indicates that the connection is properly made.

This application claims priority from provisional application Ser. No. 60/879,297, filed on Jan. 8, 2007, which is incorporated herein in its entirety.

### FIELD OF THE INVENTION

The present invention relates to seating indicators for separable electrical connectors, and in particular, a view portal seating indicators for separable electrical connectors such as loadbreak connectors and deadbreak connectors.

### BACKGROUND OF INVENTION

Loadbreak connectors used with 15, 25 and 35 KV switchgear generally include a power cable elbow connector having one end adapted for receiving a power cable and another end adapted for receiving a loadbreak bushing insert. The end adapted for receiving the bushing insert generally includes an elbow cuff for providing an interference fit with a molded flange on the bushing insert. This interference fit between the elbow cuff and the bushing insert provides a moisture and dust seal therebetween.

An indicator band may be provided on a portion of the loadbreak bushing insert so that an inspector can quickly visually determine proper assembly of the elbow cuff and the bushing insert. Because of the high voltages, the indicator band has to be visible from a distance of 8-10 feet or more. Oftentimes, these indicator bands are not easily viewed and it is difficult to determine if a proper connection is made. Accordingly, there is a need for a seating indicator that can be easily viewed and that provides positive indication that a connection is properly made.

### SUMMARY OF THE INVENTION

In accordance with the present invention, view portal seating indicators for loadbreak and deadbreak connectors are provided. In a first embodiment, the seating indicator includes: an elbow connector with an elbow cuff having an extended portion at the end and a plurality of openings located circumferentially on the extended portion; and a bushing insert having a mid-section and an indicating band extending around a portion of the midsection. Proper insertion of a bushing insert into the elbow connector permits the indicating band to be viewed through the openings and indicates that the connection is properly made. For increased visibility, the indicating band can have a highly visible color. Preferred colors are white, red, green, orange or yellow.

Each of the plurality of openings can be round or oval and have a diameter that is greater than the distance between adjacent openings. Preferably, the width of the indicating band is greater than the diameter of the openings so that the indicating band can be easily viewed through the openings. In another embodiment, each of the plurality of openings is substantially rectangular and has a width and is separated from an adjacent opening by a distance. Preferably, the width is greater than the distance. In a further embodiment, each of the plurality of openings is substantially rectangular and has a height and the indicating band has a width. Preferably, the width is greater than or equal to the height.

In a second embodiment, the seating indicator includes: an elbow connector with an elbow cuff having an extended portion at the end and a plurality of notches located circumferentially at the end of the extended portion and a bushing insert having a mid-section with an indicating band extending around a portion of the mid-section. Proper insertion of a bushing insert into the elbow connector permits the indicating band to be viewed through the notches and indicates that the connection is properly made. In one embodiment, each of the plurality of notches is substantially rectangular and has a width and the notches are separated from adjacent notches by a distance. Preferably, the width of the indicating band is greater than the distance between the adjacent notches. The indicating band can have a highly visible color, such as white, red, green, orange or yellow so that it can be viewed from a distance of at least 8 feet. However, the color of the indicating band is not intended to limit the scope of the invention in any way.

In another embodiment, each of the plurality of notches is substantially rectangular and has a height and the indicating band has a width. Preferably, the width of the indicating band is greater than or equal to the height of the notches.

### BRIEF DESCRIPTION OF THE FIGURES

The preferred embodiments of the view portal seating indicator of the present invention, as well as other objects, features and advantages of this invention, will be apparent from the following detailed description, which is to be read in conjunction with the accompanying drawings wherein:

FIG. 1 is a side elevation view of prior art loadbreak connectors, namely, a power cable elbow, a loadbreak bushing insert and a universal bushing well;

FIG. 2 is an enlarged cross-sectional view of the mating interface between the prior art power cable elbow and loadbreak bushing insert illustrated in FIG. 1;

FIG. 3 is an enlarged cross-sectional view of the mating interface between the prior art power cable elbow and loadbreak bushing insert illustrated in FIG. 1 and shows the first embodiment of the view portal seating indicator; and

FIG. 4 is an enlarged cross-sectional view of the mating interface between the prior art power cable elbow and loadbreak bushing insert illustrated in FIG. 1 and shows the second embodiment of the view portal seating indicator.

### DETAILED DESCRIPTION OF THE INVENTION

The view portal seating indicator of the present invention is used on load break connectors, in particular, load break connectors as described in U.S. Pat. No. 5,795,180 to Siebens; U.S. Pat. No. 6,168,447 to Stepniak; and U.S. Pat. No. 7,044,760 to Borgstrom, et al., all of which are incorporated herein in their entirety.

The view portal seating indicators are located at the connection point between a bushing insert and elbow connector and they provide visual verification that the connection has been properly made. The view portal seating indicators include a brightly colored band around the mid-section of the bushing insert and a view portal on an extended elbow cuff of the elbow connector. The extended elbow cuff is from about 0.25 inch to about 3 inches longer than a standard elbow cuff, preferably about 0.50 inch to 2 inches longer. The extra length is required so that the view portals do not jeopardize the integrity of the seal formed by the elbow cuff.

In a first embodiment of the view portal seating indicator, the view portal is formed by a plurality of openings located circumferentially around the lower end of the extended elbow cuff. These openings can have any shape, i.e., square, round, oval, diamond or rectangular, but regardless of the shape, the openings must be sufficiently large so that the colored band on the surface of the bushing insert can be easily viewed through the openings from a distance of at least 8 to 10 feet. The size and shape of the openings are not intended to be limitations of the invention and openings of any size and shape that allow the colored indicating band to be viewed are within the scope of the present invention. When the bushing insert is properly inserted into the elbow connector, the user can view the brightly colored band through the view portals and confirm that a proper connection has been made.

In a second embodiment of the view portal seating indicator, the view portal is formed by a plurality of notches that extend circumferentially around the lower end of the extended elbow cuff. When the bushing insert is inserted into the elbow connector, the indicating band can be viewed through the notches as a pattern of longitudinal stripes. When the user views this pattern, it verifies that the connection is properly made. If the elbow connector isn't properly connected to the bushing insert, the extended elbow cuff does not completely cover the indicating band and the user views a brightly colored band that extends continuously around the bushing insert, which indicates an improper connection. Although the notches are described as rectangular in shape, they can have almost any size and shape as long as they form a pattern that can be viewed from a distance of about 8 to 10 feet. The important aspect of the invention is that, when the elbow connector and the bushing insert are properly connected, the extended elbow cuff covers the indicating band on the bushing insert so that a continuous band cannot be viewed by the user.

Preferably, the indicating band on the surface of the mid-section of the bushing insert is brightly colored so that it can be viewed from a distance. The preferred colors are yellow and orange, although the invention is no way limited by the color of the indicating band. The bright colors allow a user to stand 8-10 feet or more away from the assembly and still easily view the pattern formed by the notches and verify that a continuous band is not visible at the end of the elbow cuff. This is important because of the high voltages that are conducted and the potential danger to a user if he or she cannot see the indicating band through the view portals from a distance.

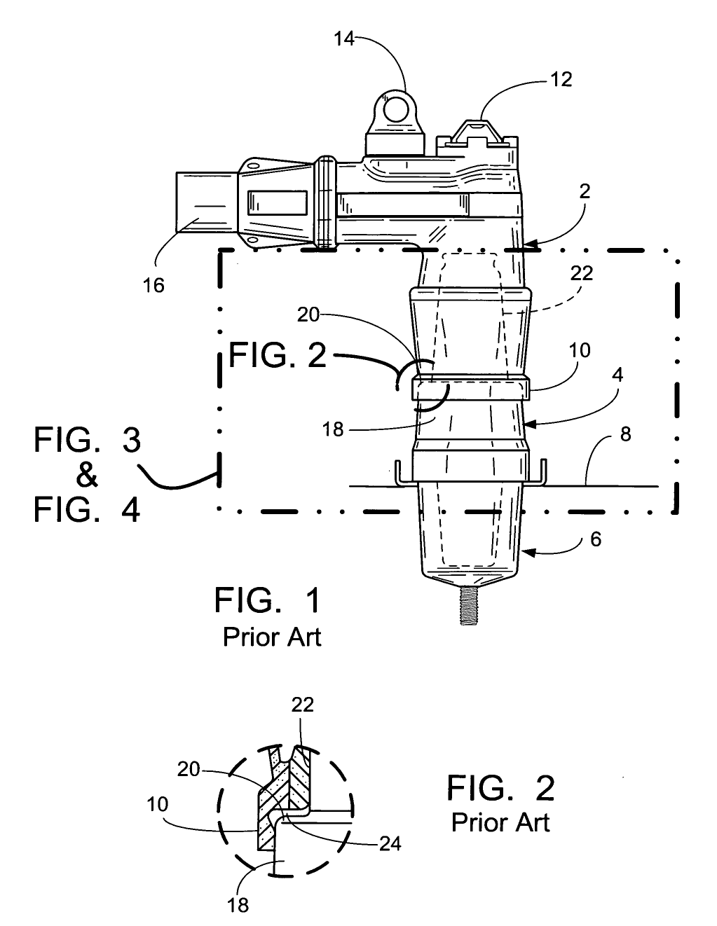

Referring now to the drawings, FIGS. 1 and 2 illustrate prior art loadbreak connectors. FIG. 1 illustrates a power cable elbow connector 2 coupled to a loadbreak bushing insert 4, which is seated in a universal bushing well 6. The bushing well 6 is attached to an apparatus face plate 8. The power cable elbow connector 2 includes a first end adapted for receiving a loadbreak bushing insert 4 and having a flange or elbow cuff 10 surrounding the open receiving end thereof. The power cable elbow connector 2 also includes an operating eye 12 for providing “hot-stick” operation (i.e., operating when the connector is under a load) and a test point 14 which is a capacitively coupled terminal used with appropriate voltage sensing devices. A power cable receiving end 16 is provided at the opposite end of the power cable elbow connector 2 and a conductive member extends from the receiving end to the bushing insert receiving end for connection to a probe insertion end of the bushing insert 4.

Referring still to FIGS. 1 and 2, the loadbreak bushing insert 4 includes a mid-section 18 having a larger dimension than the remainder of the bushing insert 4. The mid-section 18 includes a transition shoulder portion 20 between the mid-section and an upper section 22 which is inserted into the power cable elbow connector 2. As more clearly illustrated in FIG. 2, which is an enlarged cross-section of the connector interface, the elbow cuff 10 and side portion of the mid-section 18 for the bushing insert 4 provides a moisture and dust seal through an interference fit therebetween.

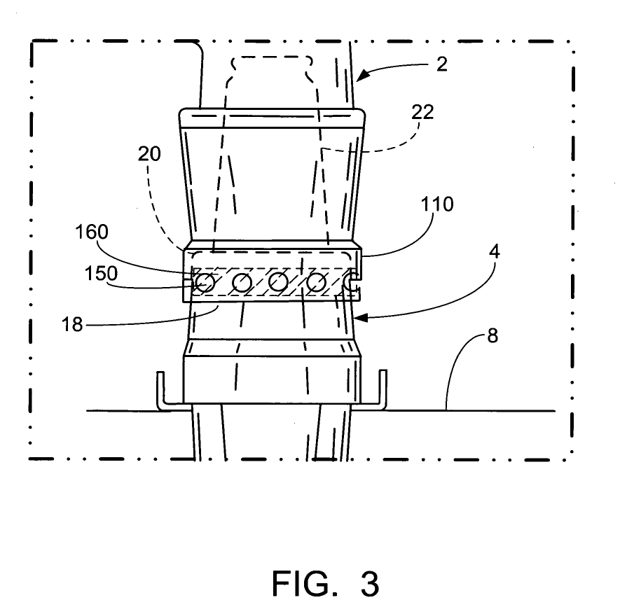

FIG. 3 shows a first embodiment of the view portal seating indicator that includes an extended elbow cuff 110 on the elbow connector 2, which extends past the transition shoulder portion 20 of the bushing insert 4 and onto a portion of the mid-section 18 of the bushing insert 4. A plurality of openings 150 located near the end of the extended elbow cuff 110 extends around the entire circumference of the extended cuff 110. Round openings 150 are shown in FIG. 3, but other shapes can be used, such as oval, square, diamond or rectangular. All of these shapes, as well as variations and/or combinations thereof, are within the scope of the invention. Preferably, the openings 150 have a minimum distance between the opposing sides of from about 0.125 inches to 0.750 inches, most preferably from about 0.250 to about 0.500 inches. An indicating band 160 is located on the surface of the mid-section 18 of the bushing insert 4. When the bushing insert 4 is properly inserted into the elbow connector 2, the indicating band 160 can be viewed through the plurality of openings 150. Preferably, the indicating band 160 is brightly colored and the openings 150 are sufficiently large so that the indicating band 160 can be easily viewed through the openings 150 from a distance. When the elbow connector 2 and bushing insert 4 are properly connected, the end of the elbow cuff 110 extends over the indicating band 160 and the indicating band is only visible through the openings 150.

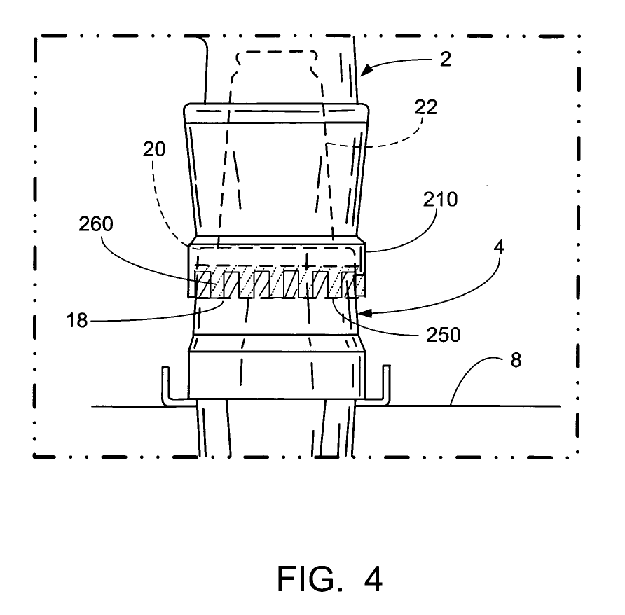

FIG. 4 shows a second embodiment of the view portal seating indicator that includes an extended elbow cuff 210 on the elbow connector 2, which extends past the transition shoulder portion 20 of the bushing insert 4 and onto a portion of the mid-section 18 of the bushing insert 4. A plurality of notches 250 is located at the end of the extended elbow cuff 210 and they extend around the entire circumference. Rectangular notches 250 are shown in FIG. 4, but other shapes can be used, such as U-shaped, diamond shaped or V-shaped, and these shapes are within the scope of the invention, as well as combinations and variations thereof. Preferably, at the end of the extended elbow cuff 210, the notches 250 have a minimum distance between the opposing sides of from about 0.125 inches to 0.750 inches, most preferably from about 0.250 to about 0.500 inches.

FIG. 4 also shows an indicating band 260 that is located on the surface of the mid-section 18 of the bushing insert 4. When the bushing insert 4 is properly inserted into the elbow connector 2, the indicating band 260 can be viewed through the plurality of notches 250 and a regular pattern is formed; the shape of the pattern depending on the shape of the notches 250. When the bushing insert 4 is improperly inserted into the elbow connector 2, the pattern is irregular and the indicating band 260 forms a ring at the end of the extended elbow connector 210. Preferably, the indicating band 260 is brightly colored and the notches 250 are sufficiently large so that the indicating band 260 can be easily viewed through the notches 250 from a distance. When the elbow connector 2 and bushing insert 4 are properly connected, the end of the elbow cuff 210 extends over the indicating band 260 and the indicating band is only visible through the notches 250 in the extended elbow cuff 210.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A seating indicator for a loadbreak connector comprising:
an elbow connector with an elbow cuff having an extended portion at the end and a plurality of openings located circumferentially on the extended portion; and
a bushing insert comprising a mid-section and an indicating band extending around a portion of the midsection,
wherein proper insertion of a bushing insert into the elbow connector permits the indicating band to be viewed through the openings.

2. The seating indicator according to claim 1, wherein each of the plurality of openings is round or oval and has a diameter and wherein each of the plurality of openings is separated from an adjacent opening by a distance, and wherein the diameter is greater than the distance.

3. The seating indicator according to claim 1, wherein each of the plurality of openings has a diameter and wherein the indicating band has a width, and wherein the width is greater than or equal to the diameter.

4. The seating indicator according to claim 1, wherein each of the plurality of openings is substantially rectangular and has a width and wherein each of the plurality of openings is separated from an adjacent opening by a distance, and wherein the width is greater than the distance.

5. The seating indicator according to claim 1, wherein each of the plurality of openings is substantially rectangular and has a height and wherein the indicating band has a width, and wherein the width is greater than or equal to the height.

6. The seating indicator according to claim 1, wherein the indicating band has a highly visible color.

7. The seating indicator according to claim 1, wherein the indicating band is white, red, green, orange or yellow.

8. A seating indicator for a loadbreak connector comprising:
an elbow connector with an elbow cuff having an extended portion at the end and a plurality of notches located circumferentially around the end of the extended portion; and
a bushing insert comprising a mid-section and an indicating band extending around a portion of the midsection,
wherein proper insertion of a bushing insert into the elbow connector permits the indicating band to be viewed through the notches.

9. The seating indicator according to claim 8, wherein each of the plurality of notches is substantially rectangular and has a width and wherein each of the plurality of notches is separated from an adjacent notch by a distance, and wherein the width is greater than the distance.

10. The seating indicator according to claim 8, wherein each of the plurality of notches is substantially rectangular and has a height and wherein the indicating band has a width, and wherein the width is greater than or equal to the height.

11. The seating indicator according to claim 8, wherein the indicating band has a highly visible color.

12. The seating indicator according to claim 8, wherein the indicating band is white, red, green, orange or yellow.
